(19) United States
(12) Patent Application Publication
(10) Pub. No.: US 2016/0310984 A1
(43) Pub. Date: Oct. 27, 2016

(54) METHOD FOR THE PRODUCTION OF COLORED STAINLESS STEEL SURFACES

(71) Applicant: POLIGRAT GMBH, München (DE)

(72) Inventors: Olaf BOEHME, Erding (DE); Siegfried PIESSLINGER-SCHWEIGER, Vaterstetten (DE)

(21) Appl. No.: 15/102,880

(22) PCT Filed: Oct. 2, 2014
(86) PCT No.: PCT/EP2014/071169

§ 371 Date: Jun. 9, 2016

(30) Foreign Application Priority Data
Dec. 18, 2013 (EP) 13005900.9

(51) Int. Cl. B05D 1/02; B05D 1/28; B05D 3/00

(52) U.S. Cl. CPC B05D 1/02; B05D 3/007; B05D 1/28

(57) ABSTRACT

The present invention relates to a method for the production of colored stainless steel surfaces having a high resistance and a wide application spectrum, and to articles comprising such stainless steel surfaces.

The present invention concerns a method for the production of colored stainless steel surfaces having a high resistance and a wide application spectrum, and to articles or stainless steel that have/has such surfaces.

### PRIOR ART

Because of their attractive luster, corrosion resistance, and favorable processability, stainless steels are used in a wide range of applications, both technical and decorative. In decorative applications such as architecture, interior design, furniture, wall coverings, kitchen equipment, automobile manufacturing, and railroad construction, there is an increasing demand for colored stainless steel surfaces. However, these should not have a “coated or enameled” appearance, but should retain their inherent qualities as stainless steel, and compared to uncolored surfaces, should show at least equivalent functional characteristics and corrosion resistance.

Rustproof steel, also commonly referred to as stainless steel, is an iron alloy, which in addition to iron can contain a number of other alloy elements such as chromium, nickel, molybdenum, copper, and others. The essential component of stainless steel alloys is the element chromium, which is contained in a minimum concentration of about 13 wt. % in order to impart increased corrosion resistance to the steel. The chromium present in the steel reacts with oxygen from the environment to form a thick oxide layer on the surface that protects said surface from corrosion (referred to as a passive layer). The quality and corrosion resistance of passive layers depend on their structure and their content of chromium oxides and iron oxides. This is classically controlled by the concentration of the alloy elements in the stainless steel. As described in WO 2008/107082, passive layers can also be subsequently treated in an aqueous solution containing a special combination of chelating and complexing agents in order to optimize their resistance to corrosion and thermal discoloration.

The methods of prior art for producing colored surfaces are as follows:

### Coating:

Coating layers are composed of an organic matrix that can be enriched with pigments as desired.

Coatings are composed of resins diluted with solvents, and are thus made stretchable or sprayable. After application, the solvents evaporate, causing the coating layers to solidify. Two-component coatings are composed of synthetic resins that are mixed shortly before application with a reactive substance (curing agent), thus giving rise to a polymerization process that solidifies the coatings.

Powder coatings are composed of plastic powders that are electrostatically applied to the metal surfaces to be coated and then thermally baked. In this process, the powder layers are heated to temperatures in the range of 200° C. to 250° C., causing them to melt, and on cooling, they form a dense, smooth, and closed layer.

For many reasons, coating layers are not particularly well-suited for the production of colored stainless steel surfaces:

Because of the chromium oxide layer on stainless steel surfaces, they generally do not show the required adhesion of the coating layers to the surfaces, so these tend to detach. In outdoor applications, in which the surfaces are exposed to sunlight, the organic coatings and pigments are attacked by the UV radiation in sunlight and destroyed. The coatings become brittle and cracked, and the pigments fade. Coating layers are significantly thicker than the layers according to the invention. This causes the surfaces to be leveled, and the metallic properties and structure of the stainless steel surfaces are lost. The luster of coating layers is produced and determined by the luster of the surfaces of the coatings rather than the metal surfaces themselves. Metallic coatings contain metal particles that give rise to the metallic effect.

Because of the properties described above, coatings are not advantageous for the production of colored stainless steel surfaces and are therefore not used.

### Enameling:

In enameling, layers composed of suspensions of low-melting-point glass powder mixed with inorganic pigments are applied to the metal surfaces to be coated and then fused at high temperatures, giving rise to a relatively thick, glasslike, and opaque surface layer. The temperatures required for enameling lie in ranges that have a substantial and detrimental effect on the structure and properties of stainless steel. Enameling is therefore not suitable for the production of colored stainless steel surfaces.

Methods for the production of colored sol-gel layers on metal surfaces using inorganic pigments are described in the patent literature. Consistently, these layers are substantially thicker than the layers according to the invention by a factor of approximately 10. They are opaque, non-transparent, and have an appearance similar to that of enamel. They have not yet found any known application on stainless steel.

### Chemical Coloring:

It is known that by treatment with aqueous solutions containing high concentrations of chromic acid and sulfuric acid at temperatures in the range of 80° C. to 100° C., a number of attractive colors can be imparted to the surfaces of stainless steels. In this case, the type and number of achievable colors can be selected only within a narrow range, and these depend on the surface state, structure, and exact composition of the alloy and bath liquid.

In treatment conducted in immersion baths, a transparent chromium oxide layer of increasing thickness forms on the stainless steel surfaces due to a chemical reaction of the metal with the chemicals in the bath over time. The respective thickness of the layer determines the color effect. This effect occurs due to interference of the incident and reflected light on the surface, similar to the effect of an oil film on water. The colors essentially correspond to the spectral colors and change depending on the viewing angle, so that large surfaces can be uniformly perceived only from a sufficiently great distance.

Chemically colored stainless steel surfaces do not show a metallic luster, but absorb up to 80% of the incident light and convert it into heat, so that they become dark indoors and are sharply heated on exposure to sunlight. Their temperature resistance is limited to approx. 180° C. At higher temperatures, the color effect is lost.

The rate of layer growth cannot be actively controlled, and is determined by the exact composition of alloy and structure, the surface state of the stainless steel, and the temperature and composition of the immersion bath. Even the smallest local deviations result in differing rates of layer growth and thus to color deviations within the surfaces.

Structural elements composed of two or more components cannot be evenly colored by this method, nor can deformed surfaces. The method is therefore suitable only for the treatment of semifinished materials such as sheets before further processing. The exact colors produced, color depth, and repeatability in series cannot be controlled. Moreover, the required chromium content of the alloy and the required homogeneity of surface state significantly limit suitability for coloring.

The usefulness of chemically colored surfaces is significantly limited by their susceptibility to soiling and abrasion. Soiling due to fingerprints, etc. produces an additional dirt film that immediately causes pronounced and unsightly discolorations. The surfaces are soft and easily damaged by abrasion.

The chemicals used to color stainless steel are extremely corrosive, poisonous, carcinogenic, and mutagenic. Their use exposes operating personnel to high risk and is therefore expected to be prohibited within the framework of the European Chemicals Ordinance (REACH). In the future, it can therefore be expected that the methods for chemical coloring of stainless steel will no longer be usable in the EU area.

### Known Sol-Gel Layers:

The colored sol-gel layers of prior art have the following disadvantages:

Sol-gel layers must be baked after application in order for them to undergo ceramization. The temperatures used in baking are in the range of 220° C. to 400° C., with a duration of at least 30 minutes. Under these conditions, stainless steel develops yellow to brownish surface discolorations. According to prior art, transparent sol-gel layers cannot be produced on stainless steel without surface discoloration unless special surface pretreatment is conducted. Opaque colored layers are possible. They show relatively high layer thickness, conceal stainless steel surface discolorations, and have an appearance similar to that of enamel. A corresponding method is described in DE 197 15 940. Such surfaces do not meet market requirements and are therefore not accepted.

### COMPOSITION OF THE INVENTION

The present invention concerns a method for the production of colored stainless steel surfaces having a high resistance and a wide application spectrum, and to articles having such stainless steel surfaces. The term “colored” means in this case that the color of the surface differs from the color of untreated stainless steel; for example, the surfaces may show all colors that can be obtained by means of inorganic pigments and mixtures thereof, such as blue, brown, red, green, yellow, white, grey, or black, with the metallic luster and the structure being produced by the stainless steel surface with its passive layer, which underlies the colored layer. The colored stainless steel surfaces manufactured according to the invention have a transparent glass-ceramic coating on a chemically optimized passive layer that contains inorganic (generally non-transparent) color pigments and is produced by thermal curing of a sol-gel coating. For the production thereof, as a first step, the natural stainless steel surface on the stainless steel surface is treated with an aqueous solution containing a special combination of chelating and complexing agents in order to impart to the surfaces the necessary resistance to thermal decoloration. In the next step, a transparent silicon-dioxide-based sol-gel coating is first applied, for example by spraying, atomizing, or rolling, and then thermally cured, with the layer thickness of the sol-gel coating on application being selected in such a way that the finished sol-gel coating preferably has a layer thickness of 1 to 3 μm after thermal curing. The coating contains inorganic color pigments that are selectively added and distributed in their arrangement and number so as to produce special coloring and luster effects. The diameter of the color pigments is preferably below 1 μm and thus consistently less than the thickness of the sol-gel layer. The usual diameters of the color pigments are in the range of 500 to 1,500 nm. The number and distribution of the pigments per coated unit area is variable and selected in such a way that the underlying stainless steel surfaces are not completely covered by the pigments and remain visible over substantial areas through the transparent coating. This imparts to the surfaces colors that have selectable color depth combined with the original metallic luster and the surface structure of the stainless steel surfaces.

The surfaces produced according to the invention are colored, transparent/reflecting, inorganic, and resistant to UV radiation, temperatures of up to 400° C., and corrosion. They are food-safe, water and dirt-repellent, and have anti-graffiti and anti-fingerprint properties.

### DESCRIPTION OF THE INVENTION

Colored stainless steel surfaces that overcome the drawbacks of the colored stainless steel surfaces of prior art and have significantly improved properties with respect to color scheme and usability, a method for the production of colored stainless steel surfaces, and articles having the colored stainless steel surfaces are the subject matter of the invention. The method according to the invention can be used to completely or partially color stainless steel articles. In particular, the surfaces can be covered in their entirety or only in specified areas. Within the scope of the present invention, reference to a “surface to be colored” is therefore to be understood as meaning that the surface to be colored can be arranged on different areas of the stainless steel article or may also be configured only at particular sites in one or more areas thereof.

The colored stainless steel surfaces according to the invention are first conditioned by pretreatment so that they are resistant to thermal discoloration due to temperatures of up to 300° C. This pretreatment is conducted in an aqueous solution containing complexing agents, and preferably a mixture of chelating and complexing agents, such as those described in the patent application WO 2008/107082 A1, for example. In this case, particular reference is made to the aqueous solutions containing complexing agents described in WO 2008/107082 A1 and the method for their use, said solutions also being suitable for the method according to the present invention.

In a following step, an inorganic sol-gel coating, preferably based on silicon oxide, is applied to the conditioned surfaces, i.e., the treated passive layer, with a preferred layer thickness of 0.5 to 5.0 μm, and more preferably 1 to 3 μm. The type of the coating is selected so as to be transparent and have a baking temperature of less than 300° C., and preferably 200° C. to 250° C., in order to prevent discoloration of the stainless steel surface during baking. The selected sol-gel coating must also show significant resistance to chemicals, temperature and corrosion. It must show lasting resistance to temperatures of up to 400° C., and in the salt spray test, must withstand at least 200 hours of exposure without damage.

Inorganic pigments are added to the sol-gel coating, with the colors thereof being freely selectable.

An essential property of the pigments is the size of their pigment granules. These should preferably be smaller than 1 μm in diameter. The size of the pigments can be adjusted as needed by means of prior crushing, for example using a ball mill, and can be ensured by filtration. This makes it possible to subsequently ensure that all of the pigment particles are incorporated into the sol-gel layer and sufficiently covered to protect them against corrosive attacks. This also ensures that the properties of the colored glass-ceramic coating are determined exclusively by the cured sol-gel itself, with the pigments having no effect on the properties of use of the colored coatings.

During the coating process, the specified size of the pigment granules allows uniform distribution of the pigments on the surfaces to be coated, improves the scattering of incident light and light reflected from the underlying stainless steel surface, and increases the optical intensity of the colors. It has been found that the inorganic color pigments should have a diameter of 500 nm to 1,500 nm.

The amount and distribution of the pigment granules in application of the sol-gel layers are selected so that they do not cover and conceal the underlying stainless steel surfaces completely, but only partially, leaving said surfaces partially uncovered and visible with their characteristic luster and structure. This leaves the metallic character of the coated surfaces unchanged.

By means of the numbers of granules per unit area, color depth and color intensity can be feely selected over a broad range, from stainless steel surfaces with a slight shimmering hue to intensely colored surfaces with a metallic luster.

The result is an extremely wide range of highly attractive colored stainless steel surfaces that cannot be achieved, or even approximated, by any previously known methods.

By means of the method according to the invention, the density and/or distribution of the inorganic color pigments make it possible for these pigments to be uniformly arranged in the coating. The result is that the metal surface remains partially visible between the pigment particles so that the coated stainless steel surface retains a metallic luster. It is highly probable in the method according to the invention that extensive and spontaneous separation of the pigments and the coating material will occur. As a result of this separation, the pigments may be deposited on the metal surface. This sedimentation occurs immediately after application of the coating material, with the coating hardening at the same time or immediately thereafter due to evaporation of the solvent contained in the coating material. As a result, a transparent, smooth layer of the sol-gel material is obtained that covers the pigments. This sol-gel coating also exerts a protective effect on the pigments, which are then no longer vulnerable to environmental effects (including corrosion).

### The Method

The invention thus concerns a method for the production of a transparent colored stainless steel surface comprising the following steps:
treatment of the surface with an aqueous solution containing complexing agents,
application of a transparent silicon dioxide sol-gel coating containing inorganic color pigments to the surface, and
thermal curing of the applied coating, wherein a transparent glass-ceramic coating is produced, and wherein the stainless steel surface to be coated is not completely covered by the color pigments.

In other words, the method according to the invention can also be described as a method for the production of a transparent colored stainless steel surface or the production of articles having a transparent colored stainless steel surface, comprising the following steps:

(i) production of a stainless steel surface and optional cleaning of the stainless steel to be colored;
(ii) treatment of the stainless steel to be colored (passive layer) by means of a method comprising
treatment of the surface to be colored with an aqueous solution containing complexing agents, preferably a combination of complexing agents, and preferably at least one oxidizing agent in order to remove iron oxide and iron atoms from the passive layer on the stainless steel surface;
rinsing of the treated surface with water, and
drying;
   (iii) production of a transparent glass-ceramic coating by means of a method comprising
application of a transparent silicon dioxide sol-gel coating containing inorganic color pigments to the treated surface of step (ii) (treated passive layer), and
thermal curing, wherein a transparent glass-ceramic coating is produced from the sol-gel coating.

The term “passive layer” is understood to refer to the oxide layer that forms on a stainless steel surface. The oxide layer is colorless, transparent, and composed primarily of iron oxides and chromium oxides. The term “transparent colored stainless steel surface” as used here means that a color impression is produced by inorganic pigments in the glass-ceramic coating, but—in areas containing no pigments—light can pass through the glass-ceramic coating, strike the underlying stainless steel surface, and be reflected therefrom, thus producing a metallic impression.

The method according to the invention for the production of colored stainless steel surfaces thus comprises steps (i) to (iii), and is preferably composed exclusively of the following steps:

In step (i), stainless steel is produced. Preferred stainless steel according to the invention is composed mainly of iron and contains at least 13 wt. % of chromium. There is no upper limit on chromium content, nor are there any limits with respect to other alloy elements such as nickel, molybdenum, manganese, silicon, copper, sulfur, or phosphorus.

Stainless steel according to the invention can have an austenitic, ferritic, or martensitic structure or a ferritic austenitic mixed structure (duplex structure).

In order to achieve homogeneous distribution of the inorganic pigments, it may be necessary in some cases to take into account one or more of the following considerations. For example, it may be advantageous to select the size of the colored pigment particles in such a way that a stable suspension cannot form because of the specific weight and size of the particles. It has been found that in the method according to the invention, the most suitable suspensions (i.e., solutions applied to the surface of the stainless steel in order to form a sol-gel coating) are those that undergo separation unless constant stirring or other measures are conducted in order to ensure that the color pigments remain homogeneously distributed and in stable suspension until the suspension is applied to the stainless steel surface. In this case, it is also advantageous to carry out application by spraying. In this variant method, it is highly probable that the suspension will already separate during application.

Similar glasslike coatings that can also be applied to stainless steel are generally known from DE 43 38 360 A1. According to example 4 of this published patent application, for example, dull coatings are produced on stainless steel. This is achieved by applying the coating in a drawing process. The result is a layer having pigments throughout its entire cross-section and on the surface, thus making it dull and rough. This type of surface cannot show a metallic appearance. Such surfaces can also be easily distinguished from transparent, colored stainless steel surfaces obtained according to the invention, as they are unsightly and difficult to clean because of their rough surface. In this case, the smooth surface with the desired metallic luster obtained according to the invention is not observed.

In the above-described method according to prior art, the separation process, which is rather desirable in this case, will generally not occur, because according to DE 43 38 360 A1, the metal compounds used regularly have a particle diameter of 1 to 100 nm, or in the case of transparent layers, 1 to 20 nm. The suspensions are therefore to be considered stable, so that the separation behavior on application of the coating to the surface that is desirable according to the invention is not observed.

Examples of stainless steels are raw materials having material numbers beginning with 1.4.

Various degrees of luster and structures can be imparted to the stainless steel surfaces by means of treatment prior to coloring. Examples of such pretreatment methods include grinding, irradiation, mechanical or electrolytic polishing, patterning, and etching.

The stainless steel can be in the form of a raw material/starting material, i.e. as sheet steel or a product, i.e. as a component of a finished structure . The surface of the stainless steel to be colored should not be coated, and in particular should be clean, grease-free, and uncorroded. Optionally, any coatings or corrosion products present may be mechanically or chemically removed before application of the method according to the invention.

For example, cleaning can be carried out by alkaline hot degreasing (e.g., with AK 161, manufactured by Schlatter), followed by rinsing of the surface with water and drying.

In step (ii), the surfaces to be colored are immersed in an aqueous solution, preferably for a period of 1-4 hours, and more preferably 3-4 hours, which contains a special combination of organic chelating and complexing agents, as described in the patent WO 2008/107082 A1 and in the present application. This is followed by an optional rinsing step. By means of this treatment, the resistance of the stainless steel surfaces to thermal discoloration is increased to such an extent that no discoloration of the bare stainless surface occurs during later thermal curing of the sol-gel layers.

The type and amount of complexing agents in the aqueous solution are preferably selected in such a way that ratio of chromium oxide to iron oxide in the passive layer is increased, preferably to a ratio of at least 4:1.

The chemical treatment according to the invention in step (ii) is not to be confused with a conventional etching process, in which metal is selectively removed from the surface of a metallic workpiece (cf. DE 92 14 890 U1 and WO 88/00252 A1). The particular effect of the method according to the invention is derived from the fact that rather than first producing a passive layer, an already-present passive layer is modified in its composition and structure by means of the process steps according to the invention in its composition and structure (step (ii)).

The presence of an intact and sealed passive layer on the stainless steel surface is the precondition for its corrosion resistance. The metallic alloy alone without a passive layer is not corrosion-resistant.

The aqueous solution used in the chemical treatment comprises a complexing agent, preferably at least two complexing agents, and preferably one oxidizing agent.

Polydentate complexing agents, also referred to as chelating agents, are preferably used as complexing agents. These polydentate complexing agents can remove iron from the passive layer by forming chelate complexes with the iron ions, contributing toward significantly increasing the ratio of chromium oxide to iron oxide in the passive layer. Hydroxycarboxylic acids, phosphonic acids, and organic nitrosulfonic acids are preferably used as complexing agents.

A further preferred component of the aqueous solution used in chemical treatment is an oxidizing agent. The amount of this oxidizing agent should preferably be sufficient to ensure that the solution has a standard electrode potential of at least +300 mV. Examples of suitable oxidizing agents include nitrates, peroxo compounds, iodates, and cerium(IV) compounds in the form of the respective acids or the corresponding water-soluble salts. Examples of peroxo compounds are peroxides, persulfates, perborates, or percarboxylates such as peracetate. These oxidizing agents can be used individually or in the form of mixtures.

A particularly suitable example of an aqueous solution that can be used in step (ii) of the treatment according to the present invention comprises the following composition:
0.5-10 wt. %, in particular 3.0-5.0 wt. %, of at least one hydroxycarboxylic acid with 1-3 hydroxyl and 1-3 carboxyl groups or (a) salt(s) thereof,
0.2-5.0 wt. %, in particular 0.5-3.0 wt. %, of at least one phosphonic acid of the general structure R′—PO(OH)₂ or (a) salt(s) thereof, wherein R′ is a monovalent alkyl, hydroxyalkyl, or aminoalkyl radical, and/or of general structure R″[—PO(OH)₂]₂ or (a) salt(s) thereof, wherein R″ is a divalent alkyl, hydroxyalkyl, or aminoalkyl radical,
0.1-5.0 wt. %, in particular 0.5-3.0 wt. %, of at least one nitroaryl or nitroalkylsulfonic acid or (a) salt(s) thereof,
0.05-1.0 wt. %, in particular 0.1-0.5 wt. %, of at least one alkyl glycol of the general structure H-(O—CHR—CH₂)ₙ—OH, wherein R is hydrogen or an alkyl radical with 1-3 carbon atoms and n is 1-5, and
0.2-20 wt. %, in particular 0.5-15 wt. %, of an oxidizing agent in an amount sufficient to ensure a standard electrode potential in the solution of at least +300 mV, wherein the remainder of the solution is water. The percentages given here refer to the respective pure substances or ions. In cases where salts or compounds containing other substances are used, such as counterions, water of crystallization, solvents, etc., correspondingly higher percentages by weight are to be used.

In a particularly preferred embodiment, the at least one hydroxycarboxylic acid comprises citric acid, and/or the at least one phosphonic acid or hydroxyethane diphosphonic acid comprises HEDP, and/or the at least one nitroaryl or nitroalkylsulfonic acid comprises m-nitrobenzenesulfonic acid, and/or the at least one alkyl glycol comprises ethylene glycol and/or butyl glycol, and the oxidizing agent comprises a nitrate, peroxide, persulfate, and/or cerium(IV) ions, in each case in the weight ratios indicated above.

The aqueous solution preferably has a pH of less than 7, and preferably less than 4. This can be achieved in that the aqueous solution contains at least one acid. In a preferred method, at least one of the complexing agents and/or at least one of the oxidizing agents is at least partially added to the solution in the form of an acid.

Step (ii) of the treatment according to present invention takes place according to a preferred embodiment in an aqueous solution having a maximum temperature of approximately 70° C. More preferably, the treatment takes place in an aqueous solution at a temperature between room temperature and 60° C. The chemical treatment in a aqueous solution is preferably conducted over a period of at least 60 min; for example, the chemical treatment with an aqueous solution can be conducted over a period of 1-4 hr.

Following the treatment with an aqueous passivating solution, the workpiece is rinsed with water, preferably deionized water, in order to remove the passivating solution, and dried before the workpiece is subjected to the treatment according to step (iii).

Step (iii) comprises the production of the glass-ceramic colored sol-gel coatings.

Sol-gel coatings are generally composed of two reaction components that are mixed in a fixed ratio shortly before processing. Finally, a dilute solution, usually an alcohol, is blended into this mixture as a third component. The concentration of the reaction mixture and the viscosity of the finished reaction batch are adjusted by means of the dilute solution.

It is obvious to the person skilled in the art that the sol-gel is first applied in the form of a liquid sol containing suspended colloidal particles, which is then converted into a gel, and after thermal curing, forms a solid, hard covering layer. Therefore, when the wording “application of the sol-gel coating” or “thermal curing of the sol-gel coating” is used, the person skilled in the art knows what state of the sol-gel system this refers to.

The sol-gel is preferably a silica sol based on silanes that are dissolved in solvents, wherein the silica sol also preferably contains one or a plurality of further sol-forming elements , preferably one or a plurality of elements from the group composed of Al, Ti, Zr, Mg, Ca and Zn, wherein these elements replace the Si atoms in the colloidal structures. Preferred sol-gel coatings/sol-gel paints are described in EP2145980. Particular reference is made here to the sol-gel coatings described in EP2145980 and the method for their use.

The starting compounds for forming the preferred sols, and ultimately the sol-gel coating, are preferably hydrolyzable silanes of the formula SiR4, wherein the 4 radicals R 2-4 comprise hydrolyzable OR′ and 0-2 non-hydrolyzable radicals R″. The starting silanes can thus be represented as Si(OR′)₄₋ₙR″ₙ, where n=0, 1, or 2. If additional sol-forming elements such as those just described are used, corresponding compounds such as AlR₃, etc. are to be selected as starting compounds according to the valences of the respective elements.

The hydrolyzable radicals OR′ are hydroxy, alkoxy, and/or cycloalkoxy radicals. Suitable examples thereof include hydroxy, methoxy, ethoxy, n-propoxy, isopropoxy, n-butoxy, i-butoxy, t-butoxy, pentoxy, hexoxy, cyclopentyloxy, and cyclohexyloxy radicals, with ethoxy, n-propoxy, and isopropoxy radicals being particularly preferred. The hydrolyzable radicals OR′ may be the same or different from one another.

The non-hydrolyzable radicals R″, if present, are alkyl and/or cycloalkyl radicals. Suitable examples thereof include methyl, ethyl, n-propyl, isopropyl, n-butyl, i-butyl, t-butyl, pentyl, hexyl, cyclopentyl, and cyclohexyl radicals, with methyl, ethyl, n-propyl, and isopropyl radicals being particularly preferred. The non-hydrolyzable radicals R″ can also be the same or different from one another.

The starting compounds of the preferred sols may consist of a single type of silane, but they frequently comprise mixtures of a plurality of silanes (and optionally, additional sol-forming starting compounds of other elements). At least one of the components of the starting compounds should preferably be a silane of the formula Si(OR′)₄₋ₙR″ₙ, where n =0, i.e. Si(OR')4. For example, a preferred sol-gel coating can comprise the starting materials TEOS (tetraethoxyorthosilane) and MTES (methyltriethoxysilane) and/or DMDES (dimethyldiethoxysilane).

Of course, other additives commonly used in the field of sol-gel systems can also be used, such as additional network-forming agents, e.g. acryloxypropyltrimethoxysilane or methacryloxypropyltrimethoxysilane, which can provide further organic crosslinks, particularly when a considerable portion of the starting compound is composed of so-called network-modifying compounds of the formula Si(OR′)₄₋ₙR″ₙ, where n=1 or 2.

In the sol, the starting compounds are partially hydrolyzed into the corresponding hydroxy compounds (such as orthosilicic acid, trihydroxyalkylsilane, etc.), a reaction that can be promoted by adding a catalyst such as an acid. Because these hydroxy compounds show a strong tendency toward condensation, they can only condense under separation of water into smaller siloxane networks. The sol already contains colloidal particles having siloxane bonds. Siloxane bonds are bonds of the form ≡Si—O—Si≡, wherein ‘≡’ symbolizes any three bonds, independently of one another, with other elements, in particular OH, OR′, and R″, giving rise to a three-dimensionally networked structure of the colloidal particles. Here, OR′ and R″ have the same meaning as indicated above.

The sol-gel coating preferably has a baking temperature of less than 300° C., preferably 200° C. to 250° C. Preferably, the sol-gel coating is colorless prior to addition of the inorganic color pigments. The color pigments are preferably added to the sol-gel as a suspension. The amount of the color pigments is preferably adjusted so that the coated surfaces are only partially covered by the pigments, with the result that the stainless steel arranged under the glass-ceramic layer, because of its passive layer, is visible through the glass-ceramic layer in the areas not containing any inorganic color pigments. Color intensity and depth can be adjusted by means of the degree of coverage with inorganic color pigments, i.e., the percentage by weight of the inorganic color pigments in the sol-gel.

The viscosity of the sol-gel coating can be set by the person skilled in the art. It is known that at a correspondingly high dilution, the sol in its solvent is sufficiently thin to be applied by spraying, atomizing, rolling, or brushing.

Suitable solvents for the sol are water, and above all, alcohols such as methanol, ethanol, n-propanol, or isopropanol, with ethanol and isopropanol being preferred because of their physical properties and the low toxicity of their vapors.

The sol-gel used in step (iii) contains inorganic color pigments, e.g. Sicocer® Black 10901, Sicocer® Blue 2502, or Sicocer® Red 2355 manufactured by BASF. One or a plurality of types of inorganic color pigments may be used according to the invention. In cases where differing types of color pigments are used, these may be used in the same or different amounts. The amounts (g/kg) of pigments used are in the range of 10 g/kg to 300 g/kg, and preferably 40 g/kg to 200 g/kg, based on the amount of sol-gel. The amount of the pigments (g/kg) is standardized by means of the specific weight of the pigments in such a way that the same number of pigment granules per unit area (pigment density) is always achieved.

The inorganic color pigments preferably have a maximum diameter of 1 μm. Preferably, the desired maximum diameter is obtained by means of sieving or filtration processes.

Mixing in of the pigments takes place in the dilute solution, making it easy to selectively adjust the desired concentration of pigments in the finished mixture. In the mixing process, a suspension of the pigments is produced by vigorous stirring, and the homogeneity thereof is of decisive importance for the uniformity of the coated surfaces. As the densities of the dilute solution and the pigments differ significantly, sufficiently vigorous stirring must be continued throughout the entire production and coating process in order to keep the suspension stable.

Before application, the sol-gel coating has a low viscosity similar to that of water and a significantly lower specific weight than the suspended pigments. For this reason, the suspensions separate immediately after application, and the pigments are deposited on the stainless steel surfaces. The small size of the pigment granules therefore ensures sufficient coverage of the pigment granules by the sol-gel layer.

The properties of the coated stainless steel surfaces are therefore determined exclusively by the properties of the sol-gel coating used rather than by the properties of the processed pigments.

The sol-gel coating of step (iii) is preferably applied by spraying or rolling, and atomizing or brushing on are also possible. However, it is preferably applied by spraying, as this makes it possible to precisely control the amount applied per unit area.

After coating, the surfaces can be dried until the solvent has evaporated. The dried surfaces are then thermally cured. Preferably, the coating does not become discolored during curing. The thermal curing of step (iii) preferably takes place at a temperature of less than 300° C., and preferably in the range of 200° C. to 300° C. Preferably, curing is carried out for a period of approx. 20 to 60 minutes, preferably 30 minutes, at temperatures in the range of 160° C. to 280° C., preferably 200° C. to 250° C. in the air. In the method according to the invention, the sol-gel (if one disregards the color pigments), is converted into a colorless, transparent, glasslike layer.

Thermal curing in the method according to the invention can consistently be carried out in such a manner than there is no change in the color of the sol-gel coating or the underlying stainless steel surface. This means that thermal stress applied both to the sol-gel and the stainless steel surface does not result in discoloration other than that caused by the color pigments themselves.

The glass-ceramic coating preferably has a thickness of 0.5-5.0 μm, preferably 1.0-5.0 μm, or 0.5-3.0 μm, and most preferably 1.0-3.0 μm. Preferably, the glass-ceramic coating has a uniform thickness, preferably with deviations of less than 10% of the layer thickness. In particular, the diameter of the inorganic color pigments/pigments is less than the diameter of glass-ceramic coating that was produced from the sol-gel.

Pigments with a diameter greater than or equal to the layer thickness of the sol-gel layer are either uncovered or covered to an insufficient degree, and therefore protrude from the surface of the coating. Such pigments cause the surface to be rough, are also exposed to the effects of corrosion, and can cause pores in the coating, resulting in local corrosion of the underlying stainless steel surface.

The method according to the invention is largely independent of the alloy and the structure of the stainless steel. In an embodiment, the method according to the invention is used on a stainless steel material composed of composite parts that are uniformly colored by the method according to the invention. In this case, the parts can be uniformly colored largely independently of their shape and form.

The surfaces according to the invention preferably have one or more of the functional characteristics listed under items 1-11 below.

1. The colored surfaces continue to show the characteristic features of the original stainless steel surface with respect to luster and surface structure.
2. The color can be freely selected, and this selection can be repeated at any time.
3. Color intensity and depth can be freely selected.
4. The coloring is uniform over the entirety of the surfaces.
5. The coloring is largely independent of the underlying material.
6. Combined structural components and finished parts can be coated, as can sheet metals and other semifinished products.
7. The colored surfaces are resistant to corrosion and UV radiation.
8. The colored surfaces are temperature-resistant up to approx. 400° C.
9. The colored surfaces are hydrophobic, easy to clean, and have anti-graffiti and anti-fingerprint properties.
10. The corrosion resistance of the non-coated surfaces, such as e.g. the reverse sides of sheets coated on the front side, is also significantly improved, and is approximately equivalent to that of a higher alloy class. This results from the effect of pretreatment in combination with baking.
11. No poisonous or hazardous substances are used in the production of the colored surfaces according to the invention. The surfaces are environmentally friendly and sustainable.

The glass-ceramic coating according to the invention produced from the sol-gel coating is transparent and non-opaque. In particular, it shows a metallic luster and reflects, independently of pigment density, a substantial portion of the incident light. This causes the surfaces to appear significantly lighter than chemically colored surfaces.

The coating is heat-resistant, with the color effect not being lost at temperatures above 180° C. and up to 300° C., in particular 200° C. or 250° C. The coating is also resistant to temperatures of up to 400° C. and can withstand at least 200 hours of exposure in the salt spray test without damage.

After cooling, the colored stainless steel surfaces are ready for use.

The invention also concerns stainless steel having a colored surface and articles composed of stainless steel or having a stainless steel surface, wherein the stainless steel surface has a transparent glass-ceramic coating containing inorganic color pigments. The colored surface can be produced according to the method described here. All embodiments described with respect to the method according to the invention are also applicable to the products with a colored surface. In particular, the passive layer and glass-ceramic layer described with respect to the method are present on the stainless steel having a colored surface.

Consistently, the stainless steel surface is covered only partially covered or optically concealed by the inorganic color pigments, so that a metallic surface arranged under the glass-ceramic layer is visible through the glass-ceramic layer in the areas not containing any inorganic color pigments. The luster and structure of the colored stainless steel surface also essentially show the luster and structure of the underlying stainless steel surfaces.

The invention concerns a stainless steel surface in the broadest sense of the term that is provided with a transparent colored glass-ceramic coating. The color of the coating is derived from the inorganic color pigments selected. These color pigments generally have a diameter of 500 to 1,500 nm. It has been found in the present invention that pigments of such diameter in particular retain a metallic luster that in all probability derives from the metal surface underlying the coating. This would be impossible, for example, in coatings containing pigments of smaller diameters, as the luster would be concealed in this case.

The invention also concerns colored stainless steel surfaces produced or producible by the method according to the invention.

### EXAMPLES

### Example 1

A stainless steel plate 1.0 mm in thickness of quality 1.4016 with a bare annealed surface (process) measuring 800×800 mm was cleaned by alkaline hot degreasing while immersed for 15 minutes and then rinsed with water. The metal sheet was then immersed in an aqueous solution containing complexing and chelating agents (Polinox-Protect, Poligrat GmbH) for 3 hours at 55° C.

The sheet was then coated by spraying while horizontal with a layer thickness of 2 μm.

The coating used was a silicon-dioxide-based sol-gel coating (Poliant, Poligrat GmbH), mixed with 100 .g/kg of a blue pigment (Sicocer® Blau 2502). Before being mixed in, the pigment was ground in the dilute solution to a particle size of less than 1 μm.

After this, the surface was dried for 10 minutes and then baked in an oven at 220° C. for 30 minutes.

After cooling, the surface showed a metallic, lustrous, deep blue appearance, and a clear reflection of the environment in its natural colors could be seen in the surface.

The surface was smooth and hydrophobic, and showed no fingerprints after being touched.

### Example 2

A stainless steel plate 1.5 mm in thickness of quality 1.4301 with a polished surface was pretreated as described in example 1 and then coated while horizontal with a silicon-dioxide-based sol-gel coating (Poliant, Poligrat GmbH), a black pigment (Sicocer® Schwarz 10901) was mixed in in an amount of 50 .g/kg, and this was then mixed with the product. The particle size of the pigment was less than 1 μm in diameter. After being dried for 10 minutes, baked for 30 minutes at 200° C., and then allowed to cool, the surface showed an anthracite grey, slightly lustrous appearance with a pronounced visible polish structure.

The surface showed a structure corresponding to the image of the polished section, and was smooth and metallic to the touch. It was hydrophobic and showed no fingerprints after being touched.

### Example 3

A welded frame structure measuring 500×600 mm composed of rectangular tubing of material 1,4301 and a metal sheet of material 1.4571 with smoothly polished welded seams was electropolished on all sides.

The work was then passivated for a period of 3 hours, rinsed, and dried.

The dry workpiece was sprayed on all sides with a silicon-dioxide-based sol-gel coating (Poliant, Poligrat GmbH) using a spray pistol. In a dilute dilution, a copper-red pigment (Sicocer® Rot 2355) was mixed into the coating substance in a concentration of 75 g/kg.

After drying, the surfaces were baked at 220° C. for a period of 30 minutes. After cooling, the structural component showed a uniformly lustrous, copper-colored surface on all sides. The various materials, including the welding seams, had uniform colors and surfaces.

The surfaces were smooth, lustrous, hydrophobic, and resistant to fingerprints.

### DOCUMENTS CITED

WO 2008/107082, DE 9214 890 U1, WO 88/00252 A1, and DE19715940.

1. Method for the production of a transparent color-coated stainless steel surface, wherein a transparent glass-ceramic coating contains inorganic color pigments covers the stainless steel surface with the inorganic, non-transparent color pigments in such a way that the coating retains a degree of transparency at which the stainless steel surface underlying the coating remains visible, comprising the following steps:
(ii) treatment of the surface with an aqueous solution containing complexing agents,
(iii) application of a transparent silicon dioxide sol-gel coating containing inorganic color pigments to the surface, and
thermal curing of the coating applied in step (iii), wherein a transparent glass-ceramic coating is produced in which the stainless steel surface to be coated is not completely covered by the color pigments.

2. Method as claimed in claim 1, wherein the inorganic color pigments have a maximum diameter of 1 μm.

3. Method as claimed in claim 1, wherein the glass-ceramic coating has a thickness of 0.5-5.0 μm.

4. Method as claimed in claim 1, characterized in that the aqueous solution in step (ii) comprises a hydroxycarboxylic acid, a phosphonic acid, and a nitroaryl or nitroalkylsulfonic acid or salts thereof.

5. Method as claimed in claim 4, characterized in that the aqueous solution of step (ii) contains the following complexing agents:
at least one hydroxycarboxylic acid with 1-3 hydroxyl and 1-3 carboxyl groups or salt thereof,
at least one phosphonic acid of general structure R′—PO(OH)₂ or salt thereof, wherein R′ is a monovalent alkyl, hydroxyalkyl, or aminoalkyl radical, and/or of general structure R″[—PO(OH)₂]₂ or salt thereof, wherein R″ is a bivalent alkyl, hydroxyalkyl, or aminoalkyl radical, and
at least one nitroaryl or nitroalkylsulfonic acid or salt thereof.

6. Method as claimed in claim 1, wherein the sol-gel coating of step (iii) is applied by spreading, spraying, or rolling.

7. Method as claimed in claim 1, wherein the thermal curing is carried out at a temperature of less than 300° C.

8. Method as claimed in claim 1, wherein the sol-gel is a silica sol based on silanes that are dissolved in solvents, wherein the silica sol also contains one or a plurality of further sol-forming elements wherein these elements replace the Si atoms in the colloidal structures.

9. Stainless steel with a transparent colored coating, wherein the stainless steel surface has a transparent colored glass-ceramic coating that contains inorganic color pigments, wherein the coating covers the stainless steel surface with inorganic, non-transparent color pigments in such a way that the coating retains a degree of transparency at which the stainless steel surface underlying the coating remains visible.

10. Stainless steel with a transparent colored coating as claimed in claim 9, wherein the inorganic color pigments have a diameter of 500 to 1,500 nm.

11. Stainless steel with a transparent colored coating as claimed in claim 9, wherein the glass-ceramic coating has a thickness of 0.5-5.0 μm.

12. Stainless steel with a transparent colored coating as claimed in claim 9, wherein the inorganic color pigments have a maximum diameter of 1 μm.

13. Stainless steel with a transparent colored coating as claimed in claim 9, wherein the colored stainless steel surface has a metallic luster and a structure that are determined by the luster and structure of the stainless steel surface arranged under the colored glass-ceramic coating.

14. Stainless steel with a transparent colored coating as claimed in claim 9, wherein a passive layer is arranged under the glass-ceramic coating, wherein the passive layer contains chromium oxide, and wherein the ratio of chromium oxide to iron oxide in the passive layer is preferably greater than 4:1.

15. Transparent color-colored stainless steel surface obtained by the method of claim 1.

16. Method as claimed in claim 8, wherein the silica sol based on silanes that are dissolved in solvents contains one or a plurality of further sol-forming elements selected from the group consisting of composed of Al, Ti, Zr, Mg, Ca and Zn, wherein these elements replace the Si atoms in the colloidal structures.

17. Method as claimed in claim 2, wherein the glass-ceramic coating has a thickness of 0.5-5.0 μm; the aqueous solution in step (ii) comprises a hydroxycarboxylic acid, a phosphonic acid, and a nitroaryl or nitroalkylsulfonic acid or salts thereof; the sol-gel coating of step (iii) is applied by spreading, spraying, or rolling and the thermal curing is carried out at a temperature of less than 300° C.

18. Method as claimed in claim 17, wherein the thermal curing is carried out at a temperature in the range of 200° C. to 300° C.

19. Method as claimed in claim 17, wherein the sol-gel is a silica sol based on silanes that are dissolved in solvents, wherein the silica sol also contains one or a plurality of further sol-forming elements, and preferably one or a plurality of elements selected from the group consisting of Al, Ti, Zr, Mg, Ca and Zn, wherein these elements replace the Si atoms in the colloidal structures.
